(19) United States
(12) Patent Application Publication
(10) Pub. No.: US 2006/0117960 A1
(43) Pub. Date: Jun. 8, 2006

(54) Brewing head for an espresso machine

(75) Inventor: Daniel Fischer, Romanshorn (CH)

Correspondence Address: KODA & ANDROLIA, 2029 CENTURY PARK EAST, SUITE 1140, LOS ANGELES, CA, 90067, US

(73) Assignee: Eugster/Frismag AG

(21) Appl. No.: 11/292,486

(22) Filed: Dec. 2, 2005

(30) Foreign Application Priority Data
Dec. 4, 2004 (DE) 20 2004 018 776.0

(51) Int. Cl. A47J 31/44

(52) U.S. Cl. 99/279

(57) ABSTRACT

In a brewing head of an espresso machine including a pressure-tightly closable brewing compartment which comprises an inlet for hot water, a filling opening for fresh coffee powder and an outlet for freshly brewed espresso, a leached-out coffee powder cake (69) is lifted, after a brewing process, by means of a force-controlled lifting piston (4, 4a) disposed in the brewing compartment up to an upper edge of the peripheral wall. From that position, the coffee powder cake (69) is laterally removed by a scraper (36). The scraper (36) is associated with a carriage (19) which can be moved along a glide face (41) above an opening of the brewing chamber and which has a seal by which, in a work position of carriage (19), the opening of the brewing chamber can be sealed. In order to obtain a reliable and wear resistant seal of the brewing compartment with a flat brewing head, a brewing compartment sleeve (3) forming the peripheral wall of the brewing compartment and substantially movable perpendicularly to the plane of the glide face (41) is force-controlledly moved, in the working position of carriage (19), through the plane of glide face (41) into a sealing position at which the brewing compartment is sealed by means of the seal. After a brewing process, it is moved back from the plane of glide face (41) into a rest position so that carriage (19) can be moved into a start position next to the brewing compartment.

### BACKGROUND OF THE INVENTION

1. Field of the Invention

The present invention relates to a brewing head of an espresso machine including a pressure-tightly closable brewing compartment as in accordance with the preamble of claim 1.

2. Description of the Related Art

An espresso machine having a brewing head showing these features comprises a carriage which is linearly movable above the brewing compartment and is shaped as a clearing scraper and serves also for the boiling water supply (EP 0 443 054 B1). The carriage includes a closing member for a brewing compartment integrally formed with a peripheral wall. The carriage including the closing member is movable between a first position for dosing the coffee powder, a second position for closable the brewing compartment and a third position for the following scraping off and discharge of the leached out coffee cake. In a first position, the closing member is disposed on one side of the opening and in its third position on substantially the opposite side of the opening of the brewing compartment. The scraper is arranged on the carriage in such a way that it is disposed in its first position at a side of the closing member averted from the opening, in the third position it is outside of the opening and during the movement from the third via the second position to the scraping off of the coffee cake, it is on the front side of the closing member. Operation of the coffee machine is effected by controlled drive means comprising a motor having a gear including a disc having a groove asymmetrically circulating as a closed loop about the axis of rotation, via which a piston rod of a lifting cylinder movable in the brewing compartment is moved. The gear includes furtheron a rocker arm via which the carriage is moved. The disadvantage of such espresso machine is that the sealing required during the course of the brewing process which can take place under a high pressure of about 12 bar between the brewing compartment and the carriage must be provided by sealing means which are disposed in the area of the glide plane of the carriage and, therefore, are subject to extensive wear. The movability of the carriage in three positions requires a correspondingly large structural volume of the machine.

In order to solve the sealing problems in the area of the brewing compartment in an operationally safe way and to produce an espresso of a very good quality, it has already been known to provide the two-part brewing head which includes in a lower part integral with the housing a force-controlled lifting piston, with a movable upper part in which a brewing piston can be moved which can be immersed from above into the brewing compartment (EP 0 756 842 A1). The upper part comprises a filling chute for freshly ground coffee, scraper wings, the brewing cylinder unit including the coffee outlet, brewing sieve, brewing piston sealing and crema valve. At the upper part of the brewing head, furtheron, a lowering lever including bearing and stop means is provided. The lower part of the brewing head is equipped with the stationary brewing compartment with the water inlet tube, the lifting piston and the drive thereof via a piston rod which is in operative connection with a control lever also supported in the lower part by which the reciprocating movement of the lifting piston is controlled. The upper part is rotatable about 360° relative to the lower part by means of a pivot which also actuates the control lever, the function positions being fixed by catches. To fill the brewing head with coffee powder, the filling chute is positioned above the brewing compartment. By subsequent rotation, the brewing cylinder is positioned above the brewing compartment and subsequently, by lowering the lowering lever, inserted into the brewing compartment. Sealing of the brewing compartment is effected by a ring seal on a lower part of the brewing piston. During the course of the subsequent brewing process for which boiling water is pressed through the water intake tube and the holes of the lifting piston into the brewing compartment, the brewing cylinder remains stationary. After the brewing process, the brewing piston is released and by lifting the lowering lever is lifted from the brewing compartment. Disposal of the coffee cake is effected by further rotation of the brewing head upper part into its start position which corresponds to the filling position. By using such brewing head, the disadvantages of the coffee machine referred to further above are eliminated; in particular, a safe and wear resistant sealing of the brewing compartment is achieved. It can be considered a disadvantage, however, that the brewing head is not very compact and, particularly in view of the lowering lever and the elements connected with it above the brewing compartment, is relatively high.

### BRIEF SUMMARY OF THE INVENTION

It is, therefore, the object of the present invention to effect a reliable, long-living, wear-resistant sealing of the brewing compartment with a compact, particularly flat brewing head.

This problem is solved by forming the brewing head with the features revealed in the characterizing clause of claim 1.

The solution as in accordance with the invention is characterized by a movable brewing compartment sleeve forming the peripheral wall of the brewing compartment, the brewing compartment sleeve being movable, substantially in a lower part of the brewing head, perpendicularly relative to the plane of the glide face of a carriage which constitutes a substantial component of an upper part of the brewing head, said carriage being able to force-controlledly travel with an external, preferably upper, section through the plane of the glide face into a sealing position to completely form the brewing compartment for a boiling process. After a boiling process, the external section of the brewing compartment sleeve is force-controlledly moved back from the plane of the glide face to make unhindered movement of the carriage possible. In this way, the sealing area is shifted from the plane of the glide face, and it is not possible that a sealing element in the sealing area will be worn off by moving the carriage along the glide face after the brewing compartment sleeve has been retracted from the sealing position. That is why the sealing of the brewing compartment can be optimized. The actuation elements of the brewing compartment sleeve as well as a lifting piston drive and, essentially, a carriage drive are preferably disposed in the lower part of the brewing head rather than on the upper part. That is why the brewing head can be shaped compact, in particular flat.

The brewing compartment is, therefore, made up between the lifting piston, the brewing compartment sleeve forming the peripheral wall, more exactly an internal section of the peripheral wall of the brewing compartment, and the carriage, more exactly a substantially piston shaped section on the underside of the carriage and in spaced relationship to the glide face thereof.

For a safe sealing of the brewing compartment, the seal according to claim 2 is formed as a ring seal and is disposed on the substantially piston shaped section on the underside of the carriage. The piston shaped section is a fixed element of the carriage and hence does not require any movable bearing and no drive means for movement at right angles relative to the shifting direction of the carriage in order to either open or close the brewing compartment. The sealing of the brewing compartment by means of this piston shaped section is effected, according to claim 3, in that the upper section of the brewing compartment sleeve is moved above the ring seal on the piston shaped section and embraces or envelops, respectively, the ring seal in this position. This arrangement is robust relative to tolerances of the position of the brewing compartment sleeve in the lifting direction thereof relative to the piston shaped section of the carriage, or the ring seal in the sealing position, respectively.

In accordance with claim 10, the plane of the glide face of the carriage is with preference substantially horizontal, whereas the brewing compartment sleeve is substantially vertically liftable and lowerable. It is this orientation, to which refers, inter alia, the definition of the upper section of the brewing compartment sleeve which, more generally, is an external section of the brewing compartment sleeve defining the opening of the brewing compartment. The configuration of the plane of the glide face of the carriage and of the brewing compartment sleeve forming the brewing compartment wall as in accordance with claim 10 is particularly useful if the coffee grinder according to claim 22 is to grind the coffee powder directly, i.e. only by using its gravity, into the brewing compartment and to this end is disposed above the brewing compartment.

The configuration of the plane of the glide face of the carriage relative to the lifting direction of the brewing compartment sleeve according to claim 10 concretely means, relative to claim 1, that in the working -position of the carriage, the brewing compartment sleeve is force-controlledly moved from below through the plane of the glide face into the sealing position and after the brewing process is downwardly moved back from the glide face into the rest position.

More in detail, in accordance with claim 4, the lifting piston in the brewing compartment sleeve can be moved in the brewing compartment in parallel thereto and communicates with a lifting piston drive. The lifting piston is a movable piston in the brewing head and has, therefore, the function of a brewing piston. In order to drive the brewing chamber sleeve, it is under a spring load, i.e. it is biased, viz. in the direction of the sealing position. The movement in the sealing position is controlled, on one hand, by the lifting piston resting against a drag ring of the brewing compartment sleeve so that over a partial stroke of the lifting piston, the brewing compartment sleeve can move only together with it. The partial stroke is defined, on one side, by the lower rest position of the lifting piston and, on the other, by its position in which it disengages from the drag ring in the sealing position of the brewing compartment sleeve to be further lifted for packing the coffee powder in the brewing compartment. Furthermore, the brewing compartment sleeve can, in its lower rest position be arrested by means of a locking nose if, after a brewing process the leached-out coffee cake is to be scraped out to the side by means of a scraper. The arresting and the release of the arresting of the brewing compartment sleeve by means of the locking nose is also effected by force control, preferably by the means according to claims 7 and 8. The spring loading of the chamber sleeve referred to above can be effected, according to claim 5, by at least one compression spring directly or indirectly engaging at the brewing compartment sleeve. To this end, spring arms in particular are solidly assigned to the brewing cylinder.

To drive the lifting piston, it is connected to a screw cylinder which can extend through the drag ring referred to above and which communicates with an electro-motoric lifting piston drive. The screw cylinder may be multiple threaded. It may be solidly connected with the lifting piston.

Preferably, however, and according to claim 21, a lifting piston rod is movably supported in a hollow screw cylinder, and in the hollow screw cylinder, a compression spring is provided which loads the lifting piston via the lifting piston rod. This arrangement is provided in combination with a crema valve according to claim 20 which is disposed in the piston shaped section of the carriage. In view of the spring load of the lifting piston, the volume of the brewing compartment may become larger by the high pressure of the fed-in boiling water whereby the coffee powder may more thoroughly be moistened prior to the brewing process under pressure, which leads to better crema formation. Only when the crema valve opens at a predetermined overpressure, the compression spring in the screw cylinder relaxes and compresses the coffee cake.

Before the ejection of the leached-out coffee powder cake, the brewing compartment sleeve is arrested, as mentioned above, by the locking nose in its rest position. For corresponding force control of the brewing compartment sleeve, a termination of the gear constituting part of an electromotoric carriage drive with a drive motor communicates with a locking disc which is so shaped that the locking nose engages into it over a partial rotation range of the locking disc.

The locking function of the locking nose is provided in that, as in accordance with claim 9, the brewing compartment sleeve is linearly movably provided in a stationary guide sleeve so that the brewing compartment sleeve cannot twist during the course of its predetermined movement and, therefore, takes the locking nose along.

The advantageous features of the brewing head include also, according to claim 11, that the carriage which substantially forms the upper part of the brewing head can be moved between two end positions only, namely a working position in which, inter alia, the brewing process takes place, and a start position in which the filling of the brewing compartment sleeve and the removal of the leached-out coffee powder cake after the brewing process, respectively, is prepared.

Clean removal of the leached-out without causing malfunctions of the brewing head is obtained, according to claim 12, in that the scraper comprises a forward scraper wall and is supported adjustable for a scraping position and a return position on the carriage in such a way that an underside of the forward scraper wall is lowered, in the scraping position of the scraper, onto the glide face of the carriage, and in the return position of the scraper is elevated at a distance above the glide face. In this way, it is avoided, particularly during the return motion of the carriage from its ejection position which corresponds to the work position, into the start position that remainders of coffee are dragged into the glide face.

This adjustment of the scraper is preferably obtained, in accordance with claim 13, in that the carriage can be moved in a sliding duct between a forward boundary at the work position of the carriage and a rear boundary at its start position and that the scraper, by striking against the forward boundary, can be reset into its back motion position, i.e. that its forward scraper wall is lifted after which, by striking against the rear boundary, it can be set into its cleaning position in which its forward scraper wall is lowerd to the slide face. This adjsutment of the scraper is thus effected by the striking of the carriage and needs no particular active drive nor control elements.

To this end, in detail, the scraper is movably supported, according to claim 14, on the carriage in the moving direction thereof, the scraper comprising a cover bottom by which it rests on the carriage. Before a front-side end of the cover bottom, the forward scraper wall is angularly shaped in downward direction. Similarly, a rear scraper wall behind the carriage is angularly shaped in downward direction, while the rearward scraper wall, however, need not, in any position of the scraper, lie on the glide face. Of significance are inclined drag noses shaped out on the cover bottom which, in the cleaning position of the scraper, rest in receiving grooves of the upper side of the carriage, when moving the scraper relative to the carriage when the scraper strikes against the front boundary, however, slide out of the receiving grooves on the upper side of the carriage and are lifted thereby, whereas when moving the scraper striking against the rear boundary relative to the carriage, the drag noses slide from the upper side of the carriage into their receiving grooves whereby the scraper takes its cleaning position. In analogy, on the other hand, the inclined drag noses can equally effectively be shaped out at the upper side of the carriage and the inclined receiving grooves in the cover bottom of the scraper.

More exactly, in accordance with claim 15, it is the forward scraper wall and the rearward scraper wall of the carriage which, when striking against the front boundery, or the rear boundary, respectively, effect the positioning of the scraper both in the direction of motion and perpendicularly thereto.

In order to avoid that the displacement of the scraper on the carriage in its longitudinal direction and perpendicularly thereto occurs already when it strikes against the leached-out coffee powder cake, the scraper is pressed by a scraper spring onto the carriage. This means that a spring force has to be overcome before the scraper together with its drag nose can slide onto the upper side of the carriage.

The above referenced electromotoric carriage drive includes, according to claim 17, the drive motor together with the gear as well as a swing lever which is in driving connection with a termination of the gear and is coupled to the carriage. Coupling to the carriage is advantageously elastically flexible by correspondingly shaping the swing lever near the carriage coupling location. The aim is that the striking of the scraper on the carriage against the front boundary or the rear boundary of the path of motion of the carriage is shock-absorbed even if coffee powder remnants are between the boundaries and the scraper. In addition, a tolerance balance is obtained making less sophisticated production possible.

The elastic flexible coupling is concretely obtained, according to claim 18, in that the swing lever comprises a driven swing lever arm and, near the carriage coupling location of the swing lever, a coupling member which communicates on one side with the carriage and, on the other, is swingably supported on the swing lever arm, and is biased by springs in a nominal position.

The above referenced screw cylinder for the displacement of the lifting piston is suitably equipped, according to claim 19, with a speed measuring device, preferably a sensor equipped with an encoder, by which a speed drop of the rotational speed of the screw cylinder can be recorded. The lifting piston drive can be stopped because, by the drop of the speed, a desired packing of the coffee powder in the brewing cylinder can be recorded from which an even packing of the coffee powder results, which is independent from the amount of coffee.

Further suitable features are included in claims 20 through 23. The advantageous effects obtained by them will be described in the following specification.

### BRIEF DESCRIPTION OF THE SEVERAL VIEWS OF THE DRAWINGS

Details and more concrete explanations of two exemplified embodiments of the brewing head and the control thereof can be taken from the following specification based on a drawing including 11 Figures wherein

FIG. 1 shows a schematic longitudinal cross section through a portion of an espresso machine in the area of a brewing head in a first embodiment with a carrage in the start position, including a brewing compartment sleeve and a lifting piston therein, each in the rest position,

FIG. 2 is a view according to FIG. 1 with the carriage however in the working position, including the brewing compartment sleeve in packed position and a lifted lifting piston immediately prior to, or during, respectively, the brewing process,

FIG. 3 is a view according to FIG. 1 but after the brewing process with the brewing compartment sleeve and the lifting piston again in the rest position,

FIG. 4 is a view according to FIG. 3 but in preparation of a scraping process of a leached-out coffee powder cake with the lifting piston in the cleaning position,

FIG. 5 is a view according to FIG. 4 but with the carriage and the scraper in the cleaning position,

FIG. 6 is a schematic cross section through the first embodiment of the brewing head in the cleaning position shown in FIG. 5 in a sectional plane rotated about 90° relative to the sectional plane in FIGS. 1 through 5.

FIG. 7 is a side view on the part of the espresso machine according to FIGS. 1, 3 und 4.

FIG. 8 is a top view on a part of the espresso machine according to FIG. 7.

FIG. 9 is a view, essentially according to FIG. 2, of the carriage, the brewing compartment sleeve and the lifting piston with the screw cylinder in a second embodiment wherein a piston rod of the lifting piston is movably supported in the screw cylinder,

FIG. 10 is a schematic representation of the control of the espresso machine, and

FIG. 11 shows selected elements of the control according to FIG. 10 in various switching positions.

### DETAILED DESCRIPTION OF THE INVENTION

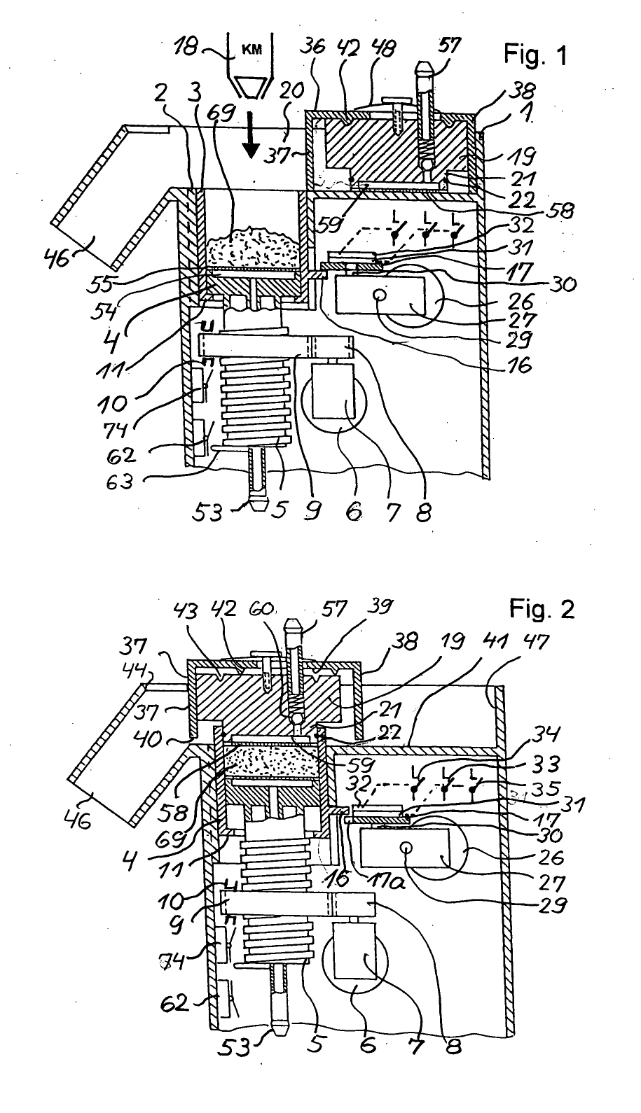

In FIG. 1, numeral 1 designates an apparatus housing of an espresso machine to which a guide cylinder 2 of a cylindric brewing compartment sleeve 3 is solidly connected. Brewing compartment sleeve 3 is supported vertically movable in the guide cylinder. In brewing compartment sleeve 3, a lifting piston 4 movable in parallell relative thereto is provided which is solidly fastened to a multiple thread screw cylinder 5. By means of this screw cylinder 5, lifting piston 4 can vertically be moved relative to housing 1.

To this end, the screw sleeve is in gear connection with an electromotoric lifting piston drive comprising a motor 6 which thus is the screw piston drive, a respective gear 7, a driving pinion 8, and a screw cylinder drive wheel 9 which includes an internal gearing corresponding with the screw of screw cylinder 5. Screw cylinder drive wheel 9 is rotatably, but not shiftably, guided in a guide 10.

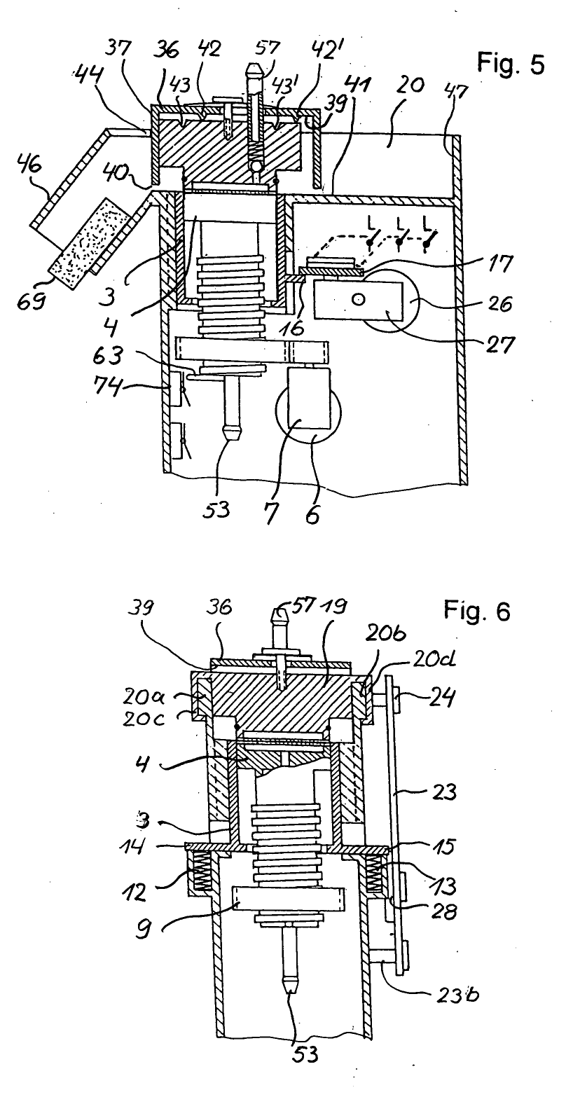

Brewing compartment sleeve 3 can be held by lifting cylinder 4 by means of a drag ring 11 located at its inner end and acting as a pressure ring, against two tightened compression springs which attempt to press, via brewing compartment spring arms 14, 15, see FIG. 6, brewing compartment sleeve 3 upwards.

A locking nose 16 solidly disposed at the periphery of brewing compartment sleeve 3 can, in combination with a locking disc 17, keep the brewing compartment sleeve in the rest position even then when lifting piston 4 in the preparation of an ejection process for the leached-out coffee powder cake is moved upward, see FIGS. 4 and 5.

Above brewing compartment sleeve 3, a coffee grinder 18 is so provided that it can grind the coffee directly into brewing compartment sleeve 3.

Also above the brewing compartment sleeve, in the rest position thereof, compare FIG. 1, a carriage 19 which can also be termed as a gliding body is horizontally movable between two end positions in a sliding duct 20 solidly assigned to the housing. The two end positions, as will be shown later, are a start position when the carriage is in its extreme right position, see FIGS. 1, 3, 4, 7, and a working position when the carriage is moved into its extreme left position, see FIGS. 2, 5.

The sliding duct 20 is laterally defined by sliding duct guide tracks 20a, 20b which are emcompassed from the outside by carriage guides 20c, 20d, see FIG. 6.

In one underside of carriage 19, a piston shaped cylindric section 21 is formed out which carries a ring seal 22. A brewing compartment not marked by a numeral formed between the upper side of lifting piston 4, the internal peripheral wall of brewing compartment sleeve 3 and an under side of the piston shaped section 21, see FIG. 2, is reliably pressure-tightly sealed by ring seal 22 when brewing compartment sleeve 3 is moved over this ring seal in sealing position of the brewing compartment sleeve. Smaller differences in height of the relative position of brewing compartment sleeve 3 and piston shaped section 21 cannot impair the sealing.

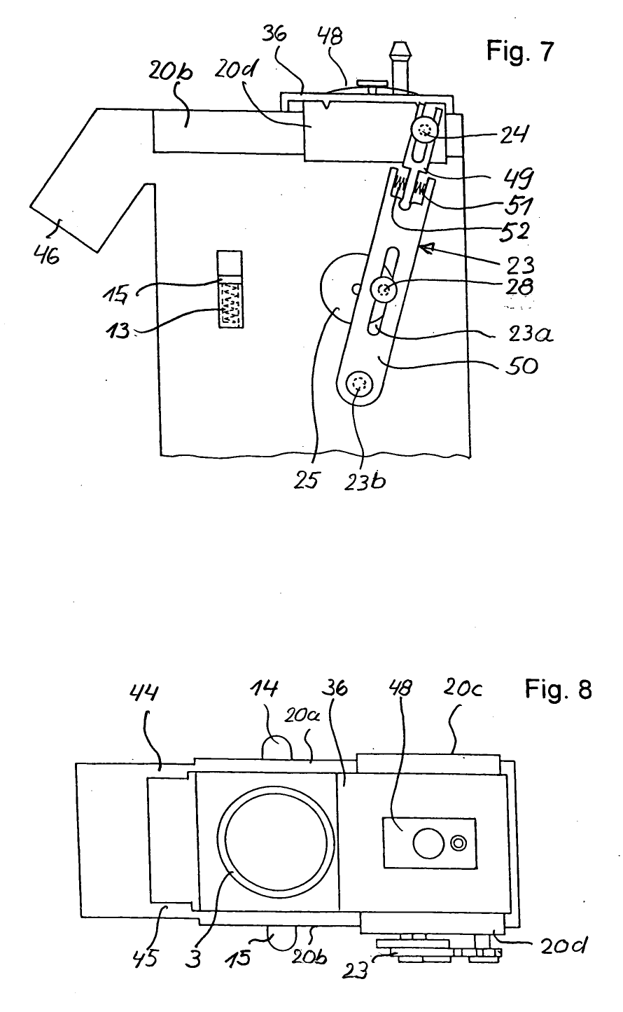

Carriage 19 and, together with it, piston shaped section 21 can be moved by an electromotoric drive which includes a swing lever 23, see FIG. 7, which is pivoted to carriage 19 via a drag bolt 24. Swing lever 23 swingable about swing lever pivoting bearing 23b is moved into each of its two end position, respectively, by a driving disc 25 driven by a further motor 26 via a respective gear 27 and a driving bolt 28 provided on drive disc 25 engaging in an elongated slot 23a of swing lever 23.

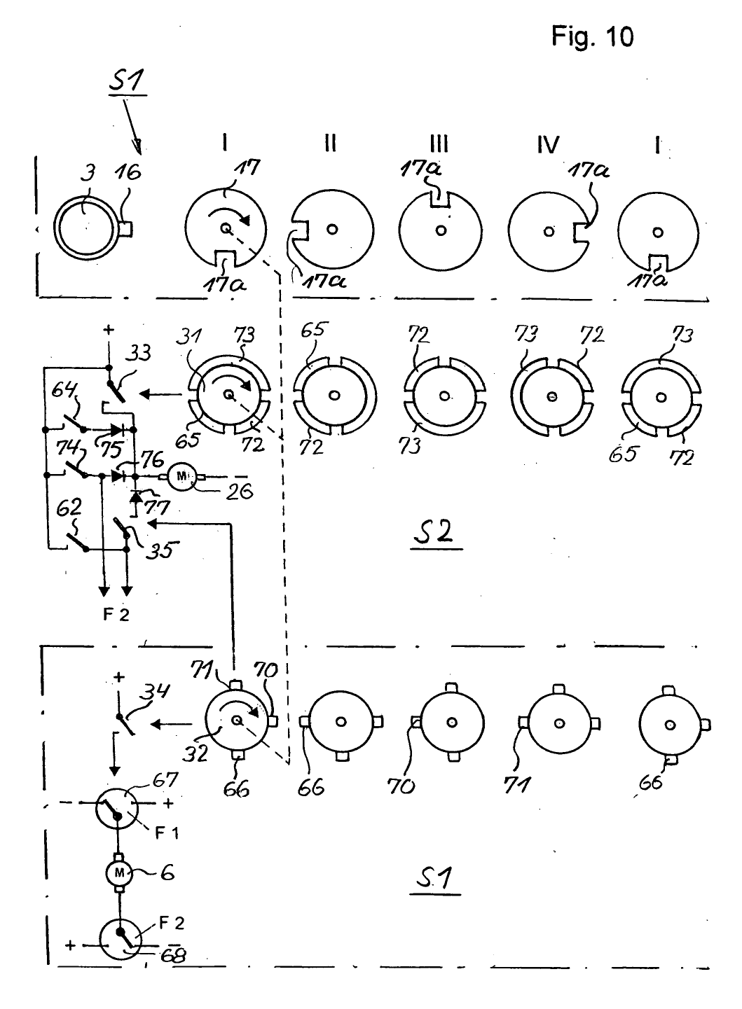

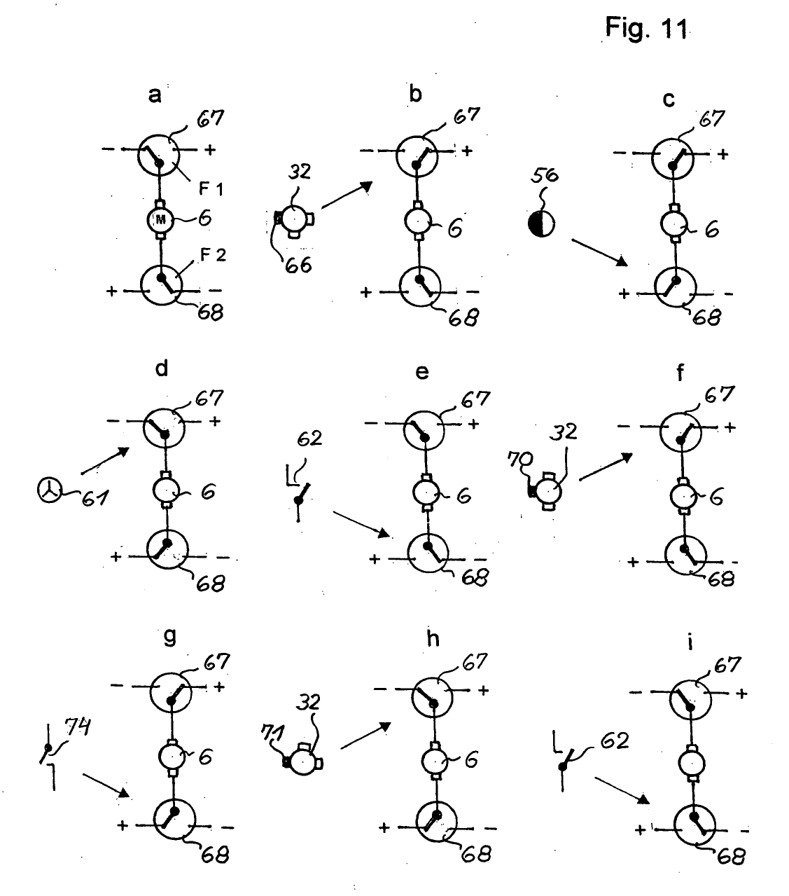

In detail, gear 27 of the electromotoric carriage drive comprises two terminations 29, 30 designed with a different reduction ratio. For one movement of swing lever 23, i.e. for a movement of the carriage with piston shaped section 21 into one of its two end positions, termination 29 for the swing lever performs a half rotation each. The second termination 30, see FIGS. 1 and 2, communicates with locking disc 17 which cooperates with locking nose 16, and with two solidly connected cam discs 31, 32. Cam discs 31, 32 control the positions of carriage 19, or its piston shaped section 21, respectively, as well as parts of the movements of the lifting piston via respective contacts 33, 34, 35. Second termination 30 rotates synchronously with the first termination 29 for swing lever 23 a quarter rotation for each half rotation of its drive disc 25 for the swing lever. The control obtained therewith will be explained in more detail in connection with FIGS. 10 and 11.

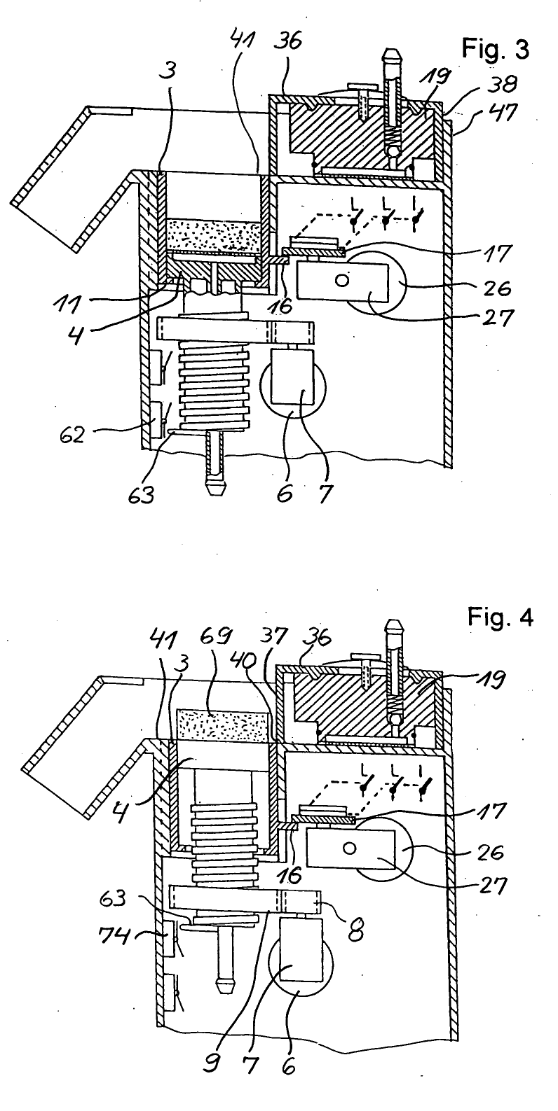

On carriage 19, a scraper 36 is movably supported in the direction of motion of the carriage. The scraper 36 comprises a forward scraper wall 37 and a rear scraper wall 38 which are angularly bent downwardly from a cover bottom so that an underside 40 of the forward scraper wall can glide on a slide face 41 of sliding duct 20 when the scraper is in its cleaning position on carriage 19. From cover bottom 39, beveled drag noses 42, 42′ are shaped out which can be received by likewisely beveled receiving grooves 43, 43′ in the carriage. In this case, underside 40 of foreward scraper wall 37 drags on the glide face 41 of sliding duct 20. If, on the other hand, drag noses 42 are disposed on the upper side of scraper 36, the underside 40 of forward scraper wall 37 is lifted off from glide face 41 and forms a free space thereto. The different heights of undersides 40 of forward scraper wall 37 are adjusted by boundaries of the motion path of the carriage in slide duct 20. One boundary is formed by two buffers 44, 45 which are provided at a work position of carriage 19 on a discharge chute 46. The other boundary is a rear wall 47 of the slidnig duct at the start position of carriage 19. When forward scraper wall 37 strikes against the two buffers 44, 45, the scraper moves backwards whereby its drag noses 42, 42′ which rest in receiving grooves 43, 43′ of carriage 19 during forward motion, are pressed out of receiving grooves 43, 43′. Thereby, scraper 36 is lifted up and remains in the elevated position, i.e. the return motion position, during the course of the complete return motion of carriage 19 into the start position at rear wall 47. When scraper 36 reaches rear wall 47 so that rear scraper wall 38 strikes against rear wall 47, the scraper is pushed forward by rear wall 47 and returns into its cleaning position in receiving grooves 43, 43′. This is supported by a scraper spring 48 provided on the upper side of the scraper, which also avoids that the scraper, when striking against the leached-out coffee powder cake 69, is moved back into its return motion position before it has ejected the coffee powder cake and strikes against the two buffers 44, 45, see FIG. 5. The cleaning position of scraper 36 when striking against the rear wall 47 of the slide duct is shown in FIG. 3.

For safe actuation of scraper 36 serves a bi-partition of swing lever 23 at its slide body coupling end. For this purpose, a coupling member 49 is swingably supported at the end of a driven swing lever arm 50, the coupling member 49 being kept in a mean nominal position by two compression springs 51, 52. In this way it is reached that the striking of carriage 19 with scraper 36 on it against buffers 44, 45 and, in the rear start position of the carriage, against rear wall 47 is effected definedly and shock-absorbingly even if coffee remnants are left between the scraper and rear wall 47 or the buffers 44, 45, respectively. By this elastically resilient coupling of the swing lever, a tolerance balance is obtained as well.

Lifting piston 4 which can also be referred to as the brewing piston is equipped with a boiling water supply tube 53, a boiling water distribution chamber 54 and with a boiling water distribution sieve 55. Piston shaped section 21 on the underside of the carriage supplementing the brewing compartment is equipped with a brew discharge tube 57, a brew sieve 58 and a brew collection chamber 59 and a crema valve 60, see particularly FIG. 2. Flexible supply and discharge ducts for boiling water supply and brew discharge are not shown. In the boiling water supply with boiling water supply tube 53, a flow meter 61 is provided shown in FIG. 11d as a symbol and which stops the boiling water supply after the passage of a predetermined amount of water and supplies a signal to a control unit S1 of the control of the lifting piston, see also FIG. 10.

Screw cylinder 5 on the lifting cylinder is equipped with a sensor and an encoder which measures the rotation speed of the screw cylinder determining therefrom a stop position for the vertical movement of lifting piston 4, as will be described later.

The brewing head described is force-controlled as follows in order to safely avoid damages, particularly in the area of the brewing compartment sleeve, of the scraper and the carriage:

In order to fill the brewing compartment encompassed by brewing compartment sleeve 3 with coffee powder by means of coffee grinder 18 disposed above the brewing compartment sleeve, carriage 19 with piston shaped section 21 on the underside thereof is in its start position, according to FIG. 1 on the extreme right on the sliding duct 20. Thereby the opening of brewing compartment sleeve 3 is free. Brewing compartment sleeve 3 is in its lower rest position in which it is held by lifting piston 4 by means of drag ring 11. The coffee grinder 18 grinds coffee into the brewing compartment sleeve in rest position while the lifting piston is also in its lower rest position. In this rest position, it closes a foot contact 62 by means of an actuation arm 63, see FIG. 1. When a predetermined amount of coffee has been ground-in by coffee grinder 18, the coffee grinder stops and closes its contact 64 which is shown in FIG. 10. Via contact 64, an electronically retarded starting pulse is supplied to drive motor 26 of the electromotoric carriage drive which remains closed by holding contact 33 by a cam 65 of cam disc 31, see FIG. 10. This starts the electromotoric carriage drive with drive motor 26 and moves, by means of swing lever 23 and the respective further drive elements of the electromotoric carriage drive, namely drive disc 25, drive disc bolt 28, coupling member 49, compression springs 51, 52 and drag bolt 24, the carriage 19 together with piston shaped section 21 on the underside of the carriage in forward direction, i.e. in FIG. 1 to the left, until scraper 36 supported on carriage 19 strikes against buffer 44, 45 and the work position of the carriage with piston shaped section 21 has been reached, as shown in FIG. 2.

Together with the movement of carriage 19, termination 30 of gear 27 of the electromotoric carriage drive rotates, according to FIG. 10, locking disc 17 as well as cam disc 31 for the carriage drive control and cam disc 32 for the lifting piston drive control about 90° from position I into position II. When reaching 90°, holding contact 33 drops from cam 65, according to position II in FIG. 10. In this position, a cam 66 of cam disc 32 for the lifting piston drive control closes contact 34 which imparts the starting pulse to the lifting piston control unit for the lifting pistion movement.

The lifting piston control unit comprises a dual electronic flip-flop circuit F1, F2 (67, 68) shown in FIG. 10 and FIG. 11 as mechanical switches. One of flip flops 67, 68 each is inserted in a supply line of motor 6 of the electromotoric lifting piston drive and the other flip flop is inserted into the drain of this motor. In their start position I in FIG. 10, both flip flops are on a negative potential, see also FIG. 11a.

The above-mentioned starting pulse triggered by cam 66 puts flip flop F1, or 67, respectively, on a positive potential, as shown in FIG. 11b.

By switching over flip flop F1 67, motor 6 of the lifting piston drive starts and moves the lifting piston via gear 7, driving pinion 8, screw cylinder drive wheel 9 and screw cylinder 5 upwards. This causes that the coffee powder filled in before is packed, as indicated in FIG. 2 by 69. For this stroke of the lifting piston, recess 17a of locking disc 17 is located above locking nose 16 of brewing compartment sleeve 3, as shown in FIG. 10 by position II, and locking nose 16 can pass through recess 17a so that brewing compartment sleeve 3 follows, under the pressure of compression springs 12, 13, the lifting pinion 4 during a partial stroke until an upper part of lifting piston 4 (not designated) has moved over the piston shaped section 21 on the underside of carriage 19, as can also be seen from FIG. 2. The brewing compartment thus closed is safely locked by means of ring seal 20 on piston shaped section 21 in this sealing position of brewing compartment sleeve 3. This position of brewing compartment sleeve 3, to make sure, may be signalled by actuated brewing compartment sleeve position contact 80, see FIG. 6, and permit the brewing process. The position taken in FIG. 2 by carriage 19 is referred to as the work position.

Lifting piston 4 may further be lifted, beyond the partial stroke where brewing compartment sleeve 3 follows the lifting piston, by means of screw cylinder 5 in order to pre-pack the coffee powder independently from the amount of coffee in a defined measure. To this end, a sensor with an encoder 56 of the screw cylinder measures the upward movement of lifting piston 4 by recording the rotation speed of the screw, cylinder. When reaching a determined speed drop caused by the strain on motor 6 during coffee powder packing, encoder 56 switches the motor off by emitting a stop pulse to flip flop F2 68 as shown in FIG. 11 by position c: Flip flop F2, 68 switches to a positive potential and thus separates motor 6 of the lifting piston drive from the power source. At the same time, a signal for the start of the brewing is given to a boiling water pump not shown in the drawing.

Having obtained a predetermined amount of boiling water recorded by flow meter 61 disposed in the boiling water supply, the flow meter emits a signal to flip flop F1, 67, as indicated in FIG. 11, position d. Thereby, the sense of rotation of lifting piston motor 6 is reversed, motor 6 is started and lifting piston 4 travels downwards in its rest position. This rest position is illustrated in FIG. 3 in which brewing compartment sleeve 3 is in its rest position as well after having strained compression springs by means of drag ring 11.

As soon as lifting piston 4 has reached its rest position, actuation arm 63 of screw cylinder 5 closes foot contact 62 which emits a stop signal to flip flop F2, 68 as shown in FIG. 11, position e. This causes that motor 6 of the lifting position drive is cut off from the power supply and is stopped. At the same time, foot contact 62 in the path of motion of screw cylinder 5 emits a start signal to the electromotoric carriage drive with drive motor 26.

Since cam disc 32 of the lifting piston drive control rotates synchronously with locking disc 17 and cam disc 31, cams 66, 70, 71 of cam disc 32 keep contact 35 open in all positions except position II in FIG. 10. Contact 35 is, therefore, closed only in position II in FIG. 10, and it is only in this position that foot contact 62 can emit a starting pulse to drive motor 26 of the carriage drive. This avoids that, when one function cycle has been finished, a further function cycle will immediately be initiated when after the end of one function cyle foot contact6 62 is closed. The starting pulse remains, electronically retarded, on drive motor 26 of the carriage drive until cam 72 of cam disc 31 closes holding contact 33 of drive motor 26. After the start of the motor, termination 29 of the swing lever drive rotates drive disc 25 of the swing lever about 180° in the same direction of rotation as in the foregoing rotation so that swing lever 23 is moved into its lower start position which is shown in FIG. 7 and to which corresponds the start position of carriage 19 in the extreme right position in sliding duct 20. The start position taken anew by carriage 19 is shown in FIG. 3.

In addition, termination 30 of gear 27 of the carriage drive rotates cam discs 31, 32 about 90°, and holding contact 33 is relieved by cams 72 so that drive motor 26 of the carriage drive is stopped as shown in FIG. 10 by position III.

When the rear position, i.e. in FIG. 3 the right start position, of carriage 19 has been reached, cam 70 of cam disc 32 closes contact 34 which emits a signal to flip flop F1, 67 as a component of the control unit of the lower piston drive as in accordance with position f in FIG. 11. By this signal, the direction of rotation of motor 6 of the lifting piston drive is changed again, the motor starts and lifting piston 4, together with the leached out coffee powder cake 69 is lifted upwards. Since during the movement of carriage 19 into its start position locking disc 17 has rotated about 90°, recess 17a of locking disc 17 is no longer above locking nose 16 of brewing compartment sleeve 3 so that the latter can no longer follow the upward movement of lifting piston 4. Lifting piston 4 moves upwardly until it arrives at its uppermost position which is in the plane of the glide face of piston shaped section 21 of carriage 19, actuation arm 63 of screw cylinder 5 closes a head contact 74 in the path of its motion which emits a signal to flip flop F2, 68 so that it takes the switch position according to position 1 in FIG. 11, switches to positive potential and stops motor 6 of the lifting piston drive. In this way, the lifting piston remains in the uppermost position as shown in FIG. 4 where the leached-out coffee powder cake 69 is lifted to the level of the glide face of piston shaped section 21 of carriage 19.

In addition, the head contact 74 in the path of motion of actuation arm 63 emits, in the position shown in FIG. 4, a start pulse to drive motor 26 of the carriage drive, the start pulse being electronically retarded and remains on the motor 26 until cam disc 31 has rotated so far that cam 73 closes holding contact 33. This causes that carriage 19 travels forward, i.e. in FIG. 4 to the left, into the position shown in FIG. 5 pushing, by means of lowered front scraper wall lower side 40, see FIG. 3, the leached out coffee powder cake 69 into discharge chute 46. Scraper 36 takes its cleaning position on carriage 19, as shown in FIG. 4. Only when forward scraper wall 37, as shown in FIG. 5, strikes against buffer 44, 45—buffer 45 can be seen in FIG. 8 only—scraper 36 glides on the upper side of carriage 19 and front scraper wall underside 40 is lifted above the glide face, see FIG. 5.

After the discharge, carriage 19 moves immediately, without stop, into its rear position, i.e. in FIG. 1 the right start position, because cam 73 of cam disc 31 covers 180° and, by means of holding contact 33, keeps motor 26 of the carriage drive from position III in FIG. 10 via position IV in FIG. 10 at the power supply, and holding contact 33 drops only in position 1 of FIG. 10 from cam 73. This means that drive disc 25 for driving swing lever 23, or the carriage drive, respectively, moves a complete rotation about 360° and carriage 19 with piston shaped section 21 on its underside is moved without stop into the start position in FIG. 1 and FIG. 7.

Simultaneously with this return movement of the carriage, the lifting piston is moved back to its lowermost rest position. When drive motor 26 of the carriage drive and the gear thereof with termination 30 has rotated cam disc 32 for about 90°—corresponding to the 90° cycle of termination 30—cam 71 closes contact 34. This causes that contact 34 emits a pulse to flip flop F1, 67 which switches to a negative potential, as indicated by position h in FIG. 11. Screw cylinder 5 together with lifting piston 4 moves downwardly until actuation arm 63 closes foot contact 62 which subsequently emits a signal to flip flop F2, 68 which switches motor 6 to negative potential, see position i corresponding to position a in FIG. 11. In this position, the drive of screw cylinder 5 is stopped and the lifting piston is in its lowermost rest position.

Since in this rest position contact 35 is opened through cam 71 of cam disc 32, see position I in FIG. 10, a start pulse to drive motor 26 of the carriage drive is avoided by foot contact 62 which, otherwise, would of new trigger an uncontrolled start of the functions described. Rather, a full working cycle remains finished, and all functional elements are in the start position, prepared for a new working cycle which is started by activating the coffee grinder.

In FIG. 10, the functional elements which belong to the control unit for the lifting piston drive, on one hand, and which can be associated with the control unit for the carriage drive, on the other, are summarized.

As concerns control unit S2 for the carriage drive with drive motor 26, it should be noted that diodes 75, 76, 77 arranged therein effect that the control pulses by contacts 64, 62, 74, depending on the positions of cam discs 31 und 32, will reach the desired functional elements only.

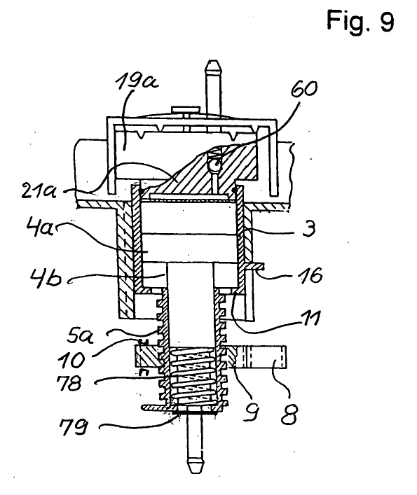

In the second embodiment of the brewing head shown in FIG. 9, equal functional elements are designated, as in the first embodiment, with respective reference numerals, similar functional elements are designated with changed reference numerals. In the second embodiment, lifting piston 4a is movably supported within screw cylinder 5a against a compression spring 78 which sits on a, not designated, collar on the bottom of screw cylinder 5a. Lifting piston 4a is held in its shown upper end position by a ring retainer 79 attached to the bottom of its lifting piston rod 4b. The compression spring is so strong that it is not compressed during an upward movement of lifting piston 4a and the packed coffee powder by screw cylinder 5a. It will only be pressed together, via lifting piston 4a, by the high pressure of the boiling water flowing into the brewing compartment so that the brewing space is enlarged and the coffee powder is better moistened prior to the brewing process proper. This leads to improved crema formation. Only when crema valve 60 in cross sections 19a opens at about 6 bar, compression spring 78 will relax when the brewing compartment becomes smaller.

Referring to the forced control in detail described above, it should be noted that it can be effected by means of equally effective means, particularly by a micro controller. In connection with the forced control, it is essential that brewing compartment sleeve 3 is moved into its sealing position before, in the brewing compartment formed by it, the coffee powder is packed and boiling water is supplied, and that the brewing compartment sleeve is lowered from the path of motion of the carriage into its rest position before the carriage with the scraper is moved, particularly when the scraper is lowered to the slide face of the carriage.

1. Brewing head of an espresso machine including a pressure-tightly closing brewing compartment, comprising an inlet for boiling water, a filling opening for fresh coffee powder, an outlet for freshly brewed espresso and a force-controlled lifting piston (4, 4a) disposed in said brewing compartment within the peripheral wall thereof, by means of which a leached-out coffee powder cake (69) is lifted, after the brewing process, up to an upper edge of said peripheral wall from which said coffee powder cake is laterally removed by a scraper, said scraper being associated with a carriage (19) which can be moved along a glide face (41) above an opening of said brewing compartment and which has a seal by which, in a working position of said carriage (19), said opening of said brewing compartment can be sealed,
characterized by
a brewing compartment sleeve (3) forming the peripheral wall of said brewing compartment substantially movable perpendicularly to the plane of said glide face (41) which can force-controlledly be moved, in the working position (FIGS. 2, 9) of said carriage (19), through the plane of said glide face (41) into a sealing position at which said brewing compartment is sealed by means of said seal and, after a brewing process, can be moved back from the plane of said glide face (41) into a rest position so that said carriage (19) can be moved into a start position (FIGS. 1, 3, 4, 7) next to said brewing compartment.

2. Brewing head according to claim 1
characterized in
that the seal is shaped as a ring seal (22) and is provided on an essentially piston shaped section (21) on the underside of said carriage (19).

3. Brewing head according to claim 2.
characterized in
that an upper section of said brewing compartment sleeve (3) can be moved above said ring seal (22) encompassing same in the sealing position.

4. Brewing head according to at claim 1,
characterized in
that said lifting piston (4, 4a) communicating with a lifting piston drive can be moved in said brewing compartment sleeve (3) and that said brewing compartment sleeve (3) is under a spring load which tries to move said brewing compartment sleeve (3) into said sealing position,
that said brewing compartment sleeve (3) includes a drag ring (11) which under spring load can get into touch with said lifting piston (4, 4a) in order to move said brewing compartment sleeve (3) together with said lifting piston (4, 4a) over a partial stroke, and
that said brewing compartment sleeve (3) can releasably be arrested by a locking nose (16) in the rest position thereof.

5. Brewing head according to claim 4
characterized in
that the spring load of said brewing compartment sleeve (3) is effected by at least one compression spring (12, 13) indirectly or directly engaging on said brewing compartment sleeve (3).

6. Brewing head according to claim 4,
characterized in
that a screw cylinder (5, 5a) is associated with said lifting piston (4, 4a) and that said screw cylinder (5, 5a) passes through said drag ring (11) and is in gear connection with an electromotoric lifting piston drive.

7. Brewing head according to claim 4,
characterized in
that said locking nose (16) by means of which said brewing compartment sleeve can releasably be arrested when in its rest position, is in operative connection with an electromotoric carriage drive.

8. Brewing head according to claim 7,
characterized in
that said electromotoric carriage drive comprises a drive motor (26) including gear (27) and that a termination (30) of said gear (27) communicates with a locking disc (17) into which a locking nose (16) engages along a portional rotation range of said locking disc (17).

9. Brewing head according to at least one of claims 1 through 7,
characterized in
said brewing compartment sleeve (3) can linearly be moved in a stationary guide sleeve (2).

10. Brewing head according to at least one of claims 1 through 8,
characterized in
that said plane of said glide face (41) of carriage (19) is essentially horizontal and that said brewing compartment sleeve (3) is substantially liftable and lowerable.

11. Brewing head according to at least one of claims 1 through 8,
characterized in
that said carriage (19) can only be moved between two end positions, i.e. the working position (FIGS. 2, 9) and a start position (FIGS. 1, 3, 4, 7).

12. Brewing head according to claim 1,
characterized in
that said scraper (36) comprises a forward scraper wall (37) and is supported on said carriage both in a cleaning position and in a return position in such a way that one underside (40) of said forward scraper wall when in the cleaning position of said scraper (36) is lowered down to said glide face (41) of said carriage (19) and when in the return position of said scraper (36) is lifted, in a spaced relationship, above said glide face (41).

13. Brewing head according to claim 12,
characterized in
that said carriage (19) can be moved within a sliding duct (20) between a front boundary (44, 45) at the working position of said carriage (19) and a rear boundary (47) at the start position thereof, and
that said scraper (36), by striking against the front boundary (44, 45), can be adjusted to its return position and by striking against the rear boundary (47) can be adjusted to its cleaning position.

14. Brewing head according to claim 13,
characterized in
that said scraper (36) is movably supported on said carriage in the movement direction thereof, that said scraper (36) comprises a cover bottom (39) with which it can be placed on said carriage (19),
that from the front-side ends of said cover bottom (39), said forward scraper wall (37) in front of said carriage (19) and a rear scraper wall (38) behind said carriage (19) are angularly bent downwardly,
that on said cover bottom (39) beveled drag noses (42, 42′) are formed which, in the cleaning position of said scraper (36) rest in receiving grooves (43, 43′) of the upper side of said carriage (19), when moving said scraper (36) relative to said carriage (19) by striking against said scraper (36) at the front of boundary (44, 45) glide out of said receiving grooves (43, 43′) onto the upper side of said carriage (19) into the return position, and when moving said scraper (36) striking against the rear boundary (47) relative to said carriage (19) glide from the upper side of said carriage into the receiving grooves (43, 43′) in cleaning position.

15. Brewing head according to claim 14,
characterized in
that at one of the end positions of the carriage, said forward scraper wall (37) and said rear scraper wall (38) each strike against the front boundary 44, 45) or the rear boundary (47), respectively.

16. Brewing head according to claim 15,
characterized in
that said scraper (36) is pressed by a scraper spring (48) onto said carriage (19).

17. Brewing head according to claim 8,
characterized in
that the electromotoric carriage drive comprises, in addition to said drive motor (26) with the gear, a swing lever (23) which is in operative connection with one termination (29) of gear (27) and is coupled to said carriage (19), and that said swing lever (23) is resiliently, elastically, flexibly formed near a carriage coupling location.

18. Brewing head according to claim 17,
characterized in
that said swing lever (23) comprises a driven swing lever arm (50) and, near said carriage coupling location, a coupling member (49) which communicates with said carriage (10), on one hand, and is swingably supported at said swing lever arm (50), on the other, and is biased by springs (51, 52) into a nominal position.

19. Brewing head according to claim 6,
characterized in
that said screw cylinder (5, 5a) is equipped with speed measuring means by which a drop in the speed can be recorded in order to stop the lifting cylinder drive.

20. Brewing head according to claim 6,
characterized in
that said piston shaped section (21, 21a) of said carriage (19, 19a) includes a crema valve (60).

21. Brewing head according to claim 6,
characterized in
that said lifting piston (4a) in said brewing compartment sleeve is biased by spring load to said piston shaped section (21a) of said carriage (19).

22. Brewing head according to claim 21,
characterized in
that the spring load of said lifting piston (4a) is effected by a compression spring (78) which is arranged in said hollow screw cylinder (5a) and presses against a lifting piston rod (4b) which is movable within said screw cylinder (5a).

23. Brewing head according to claim 13,
characterized in
that a coffee grinder (18) grinding directly into said brewing chamber is disposed above the opening of said brewing compartment, particularly above said sliding duct (20).
